(19) United States
(12) Patent Application Publication
(10) Pub. No.: US 2025/0280892 A1
(43) Pub. Date: Sep. 11, 2025

(54) Aerosol Generating Device Comprising a Heat Diffusion Layer

(71) Applicant: JT International SA, Geneva (CH)

(72) Inventor: Patrick Debergh, Cressier (CH)

(73) Assignee: JT International SA, Geneva (CH)

(21) Appl. No.: 18/858,917

(22) PCT Filed: May 3, 2023
(86) PCT No.: PCT/EP2023/061617

§ 371 Date: Oct. 22, 2024

(30) Foreign Application Priority Data
May 3, 2022 (EP) 22171344.9

(51) Int. Cl. A24F 40/51; A24F 40/20; A24F 40/46; H05B 3/40

(52) U.S. Cl. CPC A24F 40/51; A24F 40/20; A24F 40/46; H05B 3/40

(57) ABSTRACT

An aerosol generating device includes a cavity adapted for receiving a tobacco article; and a heater including a heating element configured to generate heat and a heat diffusion layer configured to transfer the generated heat to the tobacco article when it is received in the cavity, the heater further including a sensor system that includes at least partially the heat diffusion layer.

### FIELD OF THE INVENTION

The present invention concerns an aerosol generating device comprising a heat diffusion layer.

Particularly, the aerosol generating device according to the invention is configured to operate with a tobacco article, for example a stick, which comprises for example a solid substrate able to form aerosol when being heated. Thus, such type of aerosol generating devices, also known as heat-not-burn devices or HNB devices, is adapted to heat, rather than burn, the substrate by conduction, convection and/or radiation, to generate aerosol for inhalation.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device (HNB device). Devices of this type generate aerosol or vapour by heating an aerosol substrate that typically comprises moist leaf tobacco or other suitable vaporizable material to a temperature typically in the range 150° C. to 350° C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

To control the operation of an aerosol generating device, it is common to use one or more sensors arranged in proximity with the tobacco article. For example, a temperature sensor may be used to measure the temperature of the tobacco substrate and thus, in case of an HNB device, avoid its overheating which may conduct to its burning, or underheating which may conduct to poor user experience. Other types of sensors may be used to determine the authenticity of the tobacco article, pressure in an airflow channel, etc.

Using of several sensors inside the device may be advantageous since it allows better controlling of the device. However, a multitude of sensors inside the device can be cumbersome. Particularly, their arrangement inside the device may present an important issue which increases the cost of the device and may negatively affect its life cycle duration. Additionally, due to their arrangement in respect for example with the tobacco article, some sensors may present a low accuracy of measurements.

### SUMMARY OF THE INVENTION

One of the aims of the invention is to provide an aerosol generating device able to integrate a plurality of sensors without being cumbersome and without increasing significantly its cost and decreasing the life cycle duration.

For this purpose, the invention relates to an aerosol generating device comprising a cavity adapted for receiving a tobacco article; and a heater comprising a heating element configured to generate heat and a heat diffusion layer configured to transfer the generated heat to the tobacco article when it is received in the cavity, the heater further comprising a sensor system that comprises at least partially said heat diffusion layer.

Thanks to these features, a plurality of sensors forming the sensor system can be directly integrated into the heat diffusion layer or can use the heat diffusion layer for implement at least some operational functions of the sensor system. Since the heat diffusion layer can be arranged in contact with or very close to the tobacco article, the sensors of the sensor system can also be arranged close to the tobacco article so as the accuracy of their measurements in respect with the tobacco article can be increased. Additionally, since the heat diffusion layer makes part of the sensor system, the arrangement of the sensor system inside the device may be more compact and cost reducing.

According to some embodiments, the heat diffusion layer is a graphene layer, preferably the graphene layer being formed by inject printing.

In comparison with conventional materials used to implement a heater and/or a heat diffusion layer in aerosol generating device, graphene has a multitude of advantages.

First of all, the graphene presents a superior in-plane conductivity (up to 5000 W/m/K) at room temperature, which is far better that copper (approximately 402 W/m/K) and aluminum (approximately 237 W/m/K). This is particularly advantageous for the heat diffusion layer intended to conduct and diffuse heat from the heating element. Graphene may thus decrease the energy consumption of the device.

Additionally, graphene has little corrosion even under acid alkali and moisture than metal or polymer-based heating materials. Moreover, graphene presents a lightweight, an excellent stability, a flexibility and a low thermal inertia. The flexibility of the graphene layer makes it possible to adapt it to any shape of the tobacco article and arrange it closer, advantageously in contact, with the tobacco article.

Graphene has a high optical transparency, i.e. about 80-90% in visible light. This feature of the heat diffusion layer can be widely used in combination with different kinds of sensors, notably with optical sensors. Thus, it is possible to arrange the sensor system at least partially within the heat diffusion layer or for example at one or either side of the heat diffusion layer.

More generally, by using a graphene layer as a part of the sensor system, there are several major advantages:
thermal energy is distributed fast and evenly over the parts that comprise or that are covered with a graphene layer;
graphene is extremely rigid and conducts extremely well electricity;
graphene layers are very flexible;
graphene layers may be adapted to a wide variety of substrates;
the physical properties of graphene layers may be adapted to change its properties so that it becomes a substrate to realize different types of sensors or passive elements.

Independently of the thermal conduction properties of graphene, elements made of graphene may be used to create a large variety of sensors that may be useful for aerosol generating devices. Particularly, graphene allows to provide very thin sensors that may easily be integrated in the cavity of an aerosol generating device without needing cumbersome packages that are further not flexible. The number of types of sensors that may be realized by using graphene is very important. Also, using graphene, it is possible to realize a plurality of sensors on a single graphene sheet.

Different technologies can be used to manufacture the graphene layer. For example, it is possible to realize a graphene layer by inject printing so it may be realized on complex-shaped substrates.

According to some embodiment, the sensor system comprises one or more sensors formed at least partially by the heat diffusion layer or more sensors cooperating with the heat diffusion layer.

According to some embodiments, the or each sensor is able to detect at least one of the following events/elements:
insertion of the tobacco article inside the cavity;
movement of the tobacco article in respect with the cavity;
tactile command;
contamination level of the cavity;
electromagnetic waves, notably optical signals;
temperature;
pressure;
a chemical element;
a gas.

When a sensor is used to detect insertion of the tobacco article inside the cavity, the operation of the aerosol generating device can be activated only for example upon insertion of a tobacco article. This can avoid overheating of the device when for example the heating element is activated whereas no tobacco article is inserted into the cavity. The activation of the device can be done manually by the user or upon a predetermined event. The predetermined event may comprise the insertion as such of the tobacco article or/and puffs performed by the user. In this last case, a pressure sensor can be used to detect a pressure gradient inside the device.

In a more general case, a sensor can be used to detect any movement of the tobacco article in respect with the cavity. This movement can mean insertion of the tobacco article inside the cavity or extraction of the tobacco article from the cavity. In this last case, the operation of the aerosol generating device and notably of the heating element may be deactivated.

When a sensor is used to detect a tactile command, such a tactile command can be transmitted to the device's controller which can modify/activate/deactivate at least certain functionalities of the device based on such a command.

When a sensor is used to detect a contamination level of the cavity, it is possible for example to detect deposited contaminants in the cavity and avoid their heating or even bearing. For example, when the contamination level of the cavity is greater than a first threshold, a warning message can be sent to the user. Such a message can be sent by the controller using for example one or several LEDs or a display arranged on the device's body. Optionally, when the contamination level of the cavity is greater than a second threshold which is for example greater than the first threshold, the controller may for example deactivate the operation of the device until the cavity is not cleaned.

When a sensor is used to detect electromagnetic waves, as for example optical signals, these signals can be used for example to authenticate or identify the tobacco article. For example, the tobacco article can comprise on its surface symbols or codes that can be read optically in a visible, UV or infrared spectrum. In this case, these symbols/codes can encode data which can be verified by the device's controller.

When a sensor is used to detect a temperature, this measurement can be used by the controller to adapt the heating profile used to heat the tobacco article.

When a sensor is used to detect a pressure gradient, this measurement can be sued by the controller to activate the heating element.

Finally, when a sensor is used to detect a predetermined chemical element or a gas (such as CO), the controller can use this information for adapting the heating profile and/or for sending a warning message or any other type of message to the user.

According to some embodiments, one or several of said events/elements are able to be detected by measuring at least one of the following parameters of the corresponding sensor:
mechanical deformation;
changing of electrical conductivity;
piezoelectric effect;
changing of polarization.

For example, the insertion of a tobacco article inside the cavity or its movement within the cavity can be detected by a mechanical deformation of the corresponding sensor. Optionally, the deformation may be detected electrically or optically.

It is also possible to use piezoelectric effect to detect for example deformations while moving the tobacco article inside the cavity. For this purpose, a sensor's material (like graphene), which is not piezoelectric, may be made piezoelectric by doping. Such a material may be doped with lithium, hydrogen, potassium and fluorine, as well as combinations of hydrogen and fluorine and lithium and fluorine on either side of the lattice. In case of graphene, doping just one side of the graphene, or doping both sides with different atoms, is key to the process as it breaks graphene's perfect symmetry, which otherwise cancels the piezoelectric effect.

A tactile command or a contamination level of the cavity can be detected using changing of electrical conductivity of the corresponding sensor. For example, in case of using a sensor comprising graphene, the electrical conductivity of the graphene changes with the binding of substances, called analytes, to its surface and their chemical constituents may be identified and measured. The magnitude of the conductivity change can be correlated to the concentration of deposited contaminants.

A sensor, notably a sensor comprising a graphene layer, may be configured so that it behaves as an adaptable polarizer. This might be used to detect optical codes or symbols that are arranged on a smoking article and which have polarization properties. Additionally, a graphene layer in the form of graphene oxide (CO) may be configured as a fluorescent layer which emitted wavelength may be varied by changing the wavelength of the excitation light. For fluorescence applications, its fluorescent properties can be modulated by changing its sheet size, chemical composition and other factors. As the graphene layer acts as a fluorescent layer, it behaves as an emitting diffuser and may also be used in an optical anti-counterfeit sensor for smoking articles.

According to some embodiments, the heat diffusion layer forms at least partially transparent window designed to be arranged between a sensor and the tobacco article.

This window can notably be used to read optical codes or symbols on an external surface of the tobacco article. In this case, the tobacco article can be received in the cavity and heated at the same time while an optical sensor performs reading of these codes or symbols.

The window can be arranged in thermal contact with the opaque portion of the heat diffusion layer, possibly by a mechanical force or by gluing or by soldering, or by any process that implies a deposition process such as the one known in the realization of membranes.

The window may have any shape such as:
a cylindrical shape, not necessarily having a uniform diameter over its length;
the shape of a closed or opened ring;
a tube or ring having a rectangular or square-shaped cross section or any other non-circular cross-section;
a flat or curved plate having at least one rectangular shaped cross-section;
a window having at least two cross-sections that have different curvatures;
a window having at least one flat side and at least one curved side;
an array of transparent and thermal conductive windows.

According to some embodiments, the sensors are arranged in corner sections and/or forms an array of/on a sheet forming the heat diffusion layer.

Thanks to these features, the sensors can be arranged in appropriate locations in respect with the tobacco article when the heat diffusion layer is folded or rolled to form the cavity receiving the tobacco article. Thus, the sensors can be arranged for example circumferentially in respect with the tobacco article. Additionally, when the heating element is integrated in the heat diffusion layer, the sensor can be arranged at the periphery of the sheet to be spaced from the heating element.

According to some embodiments, the sensor system further comprises at least one optical emitter able to emit an optical signal.

According to some embodiments, said emitter is formed at least partially in the heat diffusion layer or cooperates with the heat diffusion layer.

In some embodiments, said transmitter is formed at least partially in the heat diffusion layer or cooperates with the heat diffusion layer.

For example, an optical transmitter can be integrated in the heat diffusion layer comprising graphene. Particularly, a graphene layer may be configured as a graphene light source: it allows to integrate a very thin light source in or on a heater element.

According to another example, a graphene layer may be used as a window to transmit electromagnetic radiation from a light source into the cavity, and from the heater cavity to an optical receiver. In different embodiments, the graphene layer may be made of a self-standing layer, possibly a flexible layer, arranged on a through-aperture provided in the opaque portion of the heating element.

According to some embodiments, the heating element is integrated at least partially in the heat diffusion layer.

Particularly, the heating element may be realized partially or completely within the heat diffusion layer, like a graphene layer. The graphene layer may be arranged on a flexible substrate such as Kapton, which comprises a portion that is a graphene-based sensor, or graphene based electronic structures.

An rGO (Reduced Oxide Graphene) heating element is able to easily achieve stable steady-state temperatures higher than 200° C. when a voltage of 15 V is applied, featuring a time constant of around 4 s and a heat transfer coefficient of ˜200° C. cm2/W.

According to some embodiments, the aerosol generating device further comprises a support delimiting at least partially the cavity and defining an inner surface configured to face or be in contact with the tobacco article, and an outer surface opposite to the inner surface;
the heat diffusion layer being arranged on the inner surface or on the outer surface of the support.

When the heat diffusion layer is arranged on the inner surface of the support, it can be in direct contact with the tobacco article or face the tobacco article when the tobacco article is received in the cavity. This embodiment is particularly advantageous when the heating element is integrated at least partially in the heat diffusion layer. Thus, it is possible to minimize heat lost while heating the tobacco article.

When the heat diffusion layer is arranged on the outer surface of the support, it can diffuse heat homogenously to the support and the tobacco article can be heated by the support which may be in direct contact with the tobacco article or face the tobacco article. The support can be made from any suitable heat conducting material such as aluminum, copper, SiO₂, Al₂O₃, etc. Some of these materials may be transparent. Thus, the support with the heat diffusion layer may form at least partially transparent structure.

According to some embodiments, the support is formed by at least one of the following elements:
hollow cylinder;
longitudinal bars;
transversal rings;
grid.

According to some embodiments, the heat diffusion layer is formed by a sheet. It is thus understood that the heat diffusion layer comprises a single sheet. This sheet is continuous or comprises a plurality of finger parts designed to extend longitudinally.

Alternatively, the heat diffusion layer may comprise a plurality of apertures arranged in any suitable manner.

According to some embodiments, the heat diffusion layer is substantially transparent.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of an aerosol generating device according to the invention and a tobacco article received in the aerosol generating device, the aerosol generating device comprising a heat diffusion layer, a support and a sensor system;

FIGS. 2 to 6 are schematic views showing different examples of respective arrangement of the heat diffusion layer and the support;

FIGS. 7 to 8 are schematic views showing different examples of arrangement of the sensor system in respect with the heat diffusion layer; and

FIGS. 9 to 13 are schematic views showing operation of the sensor system according to different examples of the invention.

### DETAILED DESCRIPTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heating system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “vaporizable material” or “aerosol-forming precursor” may refer to one or more of a: liquid; solid; gel; mousse; foam or other substances. The vaporizable material may be processable by the heating system of the device to form an aerosol as defined herein. The vaporizable material may comprise one or more of: nicotine; caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar. A solid aerosol forming substance may be in the form of a rod, which contains processed tobacco material, a crimped sheet or oriented strips or shreds of reconstituted tobacco (RTB).

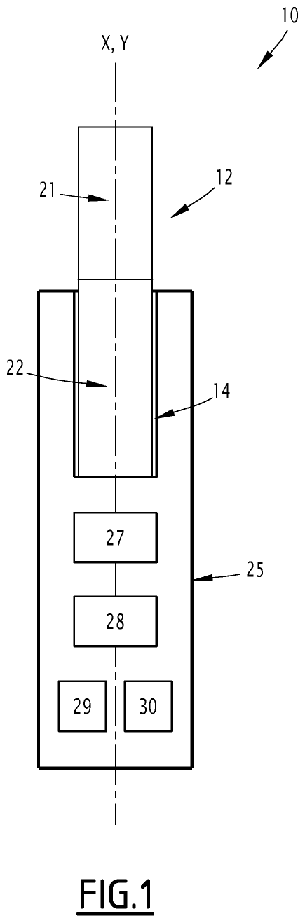

An aerosol generating device 10 according to the invention is shown in FIG. 1. As it is shown in this Figure, the aerosol generating device 10 is configured to operate with a tobacco article 12 when it is received in a cavity 14 delimited by the aerosol generating device 10.

The tobacco article 12 extends according to an article axis X which in the example of FIG. 1 coincides with a device axis Y. The tobacco article 12 has for example a generally cylindrical shape. This cylindrical shape is circular in cross-section along its length. Advantageously, according to some embodiments, the tobacco article 12 has a shape and/or dimensions which are substantially equal to those of a conventional cigarette. For example, the tobacco article 12 may form an HNB article (heat-not-burn article) having substantially the same shape and/or dimensions as a conventional cigarette. However, in some alternative embodiments, the tobacco article 12 may have other handy shapes than a conventional cigarette, such as parallelepipedal type, pebble type shape, etc. The tobacco article 12 may also be of larger or smaller size (e.g. in longitudinal or circumferential direction).

Advantageously, according to the invention, the tobacco article 12 is a conventional cigarette or is a known HNB article.

In reference to FIG. 1, the tobacco article 12 comprises a filter/cooler portion 21 and a storage portion 22. These portions can be assembled together by a common wrapper (not shown) comprising paper, aluminium foil or combinations thereof. In the example of FIG. 1, the filter/cooler portion 21 extends according to the article axis X and is adjacent to the storage portion 22. The storage portion 22 also extends along the article axis X and can for example be slightly longer than the filter/cooler portion 21. According to another example, the storage portion 22 has the same length as the filter/cooler portion 21 or is shorter than this filter/cooler portion 21.

The filter/cooler portion 21 forms a mouth end of the tobacco article 12 designed to be in contact with the user's mouth/lips. This portion 21 contains filter and/or cooling segments designed to filter and/or cool the aerosol formed by the storage portion 22 further to its heating. For example, the filter/cooler portion 21 may comprise filter segment(s) at the mouth end of the article and a tubular element (e.g. paper tube) between the filter segment(s) and the storage portion 22. In some embodiments, no filter/cooler portion 21 is provided. In this case, for example the storage portion 22 can form the mouth end of the article 12. In this case, an exchangeable filter/cooler mouthpiece can be used which can be connected to the tobacco article 12.

The storage portion 22 contains a vaporizable material as defined above. In some embodiments, the storage portion 22 may further comprise one or several heating elements which are configured to cooperate with the corresponding heating element(s) of the aerosol generating device 10 in order to heat the vaporizable material. For example, the heating elements within the storage portion 22 may present a plurality of susceptors which are able to heat the vaporizable material when they are placed within a magnetic field.

The cavity 14 is adapted to receive at least partially the tobacco article 12. The cavity 14 extends for example according to the device axis Y. Particularly, according to the example of FIG. 1, the cavity 14 is adapted to receive entirely the storage portion 22 of the tobacco article 12. Advantageously, the length of the storage portion 22 is substantially equal to the length of the cavity 14. The cross-sectional shape of the cavity 14 corresponds for example to the cross-sectional shape of the tobacco article 12. The general shape of the cavity can be defined by a support 24 (not shown in FIG. 1) which can be made from a heat conductive material such as aluminium or copper. In some cases, the support 24 can be at least partially transparent and made for example from SiO₂ or Al₂O₃. Particular shapes and arrangement's examples of the support 24 will be explained in further detail below.

Referring to FIG. 1, the aerosol generating device 10 comprises a housing 25 which comprises various internal components of the device 10 ensuring its various functionalities. For example, the housing 25 comprises a heater 27 to cause heating of the storage portion 22 of the tobacco article 12, a sensor system 28 to monitor the operation of the aerosol generating device 10, a controller 29 to control notably the operation of the heater 27, and a battery 30 to power the heater 27 and the controller 29.

The battery 30 is for example a known battery designed to be charged using the power supply furnished by an external source and to provide a direct current of a predetermined voltage. The battery 30 can be associated to a battery charger which is able to connect it to the external source and comprises for this purpose a power connector (like for example a mini-USB or USB-C connector) or wireless charging connector. The battery charger is also able to control the power delivered from the external source to the battery 30 according for example to a predetermined charging profile. Such a charging profile can for example define a charging voltage of the battery depending on its level of charge. In some alternative embodiments, instead of the battery 30, the housing 25 can comprise only a power connector connecting, for example by wire, the device 10 to an external power source. In this case, the device 10 is able to operate only when it is connected to this external power source.

The controller 29 is configured to control the operation of the heater 27 by controlling its powering by the battery 30 or in the alternative embodiment, by the external power source. For this purpose, the controller 29 is for example able to apply a predetermined heating profile to control the operation of the heater 27. In some embodiments, the heating profile may be chosen depending on the nature or type of the tobacco article 12. For example, the heating profile is chosen depending on a type of a flavouring contained in the storage portion 22 of the tobacco article 12. Additionally or alternatively, in some embodiments, the heating profile may be chosen depending on data provided by the sensor system 28 as it will be explained in further detail below. More generally, the controller 29 is able to receive measurements acquired by the sensor system 28 and process these measurements in order to determine one or several control commands.

The heater 27 comprises a heating element configured to generate heat and a heat diffusion layer 32 configured to transfer the generated heat to the tobacco article 12 and notably to the storage portion 22 when it is received in the cavity 14. In some embodiments, the heater 27 comprises a plurality of heat diffusion layers 32 as defined above.

The heating element can be powered by the battery 30 according to the heating profile chosen by the controller 29. According to different embodiments of the invention, the heating element may by integrated in the heat diffusion layer 32 or connected to the heat diffusion layer. For example, the heating element may present a resistive wire, notably a metal wire, which may extend inside at least a part of the heat diffusion layer 32. According to another example, the heating element may be realized completely with the heat diffusion layer 32, for example on a flexible substrate such as Kapton. The heating element may be made of graphene.

The heat diffusion layer 32 is arranged adjacent to the support 24 to be as close as possible to the storage portion 22 of the tobacco article 12. Advantageously, at least one of the elements chosen between the heat diffusion layer 32 and the support 24, is arranged to be in contact with the storage portion 22 or to face the storage portion 22 while being spaced from it by a small distance, comprised for example between 1 mm and 5 mm. In the first case, the storage portion 22 is heated by conduction. In the second case, the storage portion 22 is heated by convection.

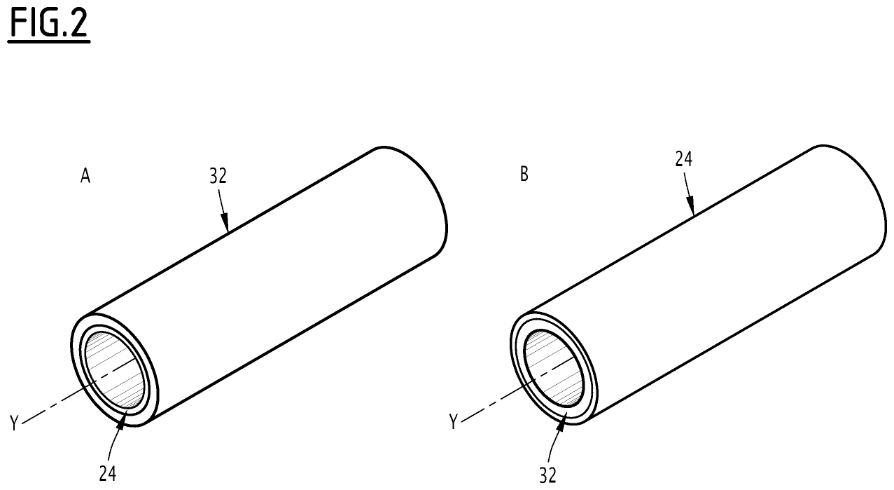

FIG. 2 shows different examples of arrangement of the heat diffusion layer 32 in respect with the support 24. Particularly, according to the example A of FIG. 2, the support 24 defines an outer surface which is in contact with the heat diffusion layer 32. In the example B of FIG. 2, the support 24 defines an inner surface which is contact with the heat diffusion layer 32. In other words, in the example A, the heat diffusion layer 32 is arranged externally in respect of the support 24 and in the example B, the heat diffusion layer 32 is arranged internally. Thus, in the example B, the heat diffusion layer 32 is intended to be in contact with the storage portion 22 of the tobacco device 12 or face directly this portion.

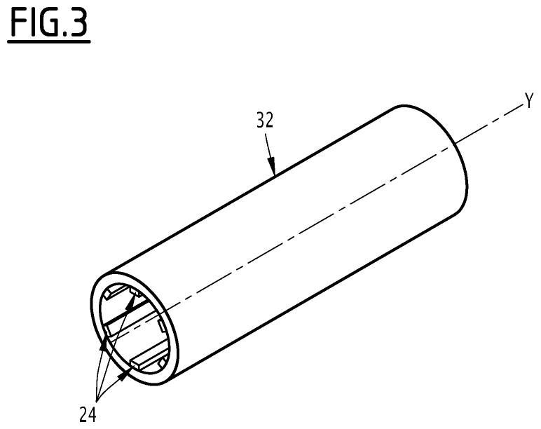

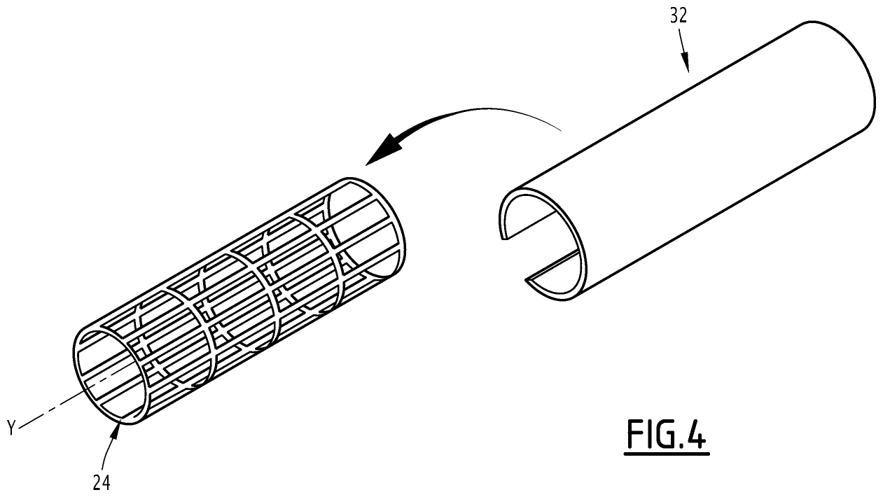

According to both examples of FIG. 2, the support 24 has a continuous cylindrical shape extending along the device axis Y. However, the support 24 can have any other suitable shape and present for example longitudinal bars, transversal rings, a grid, etc. Thus, in the example of FIG. 3, the support 24 presents longitudinal bars extending along the device axis Y. In the example of FIG. 4, the support 24 presents a grid formed by longitudinal bars extending along the device axis Y and transversal rings.

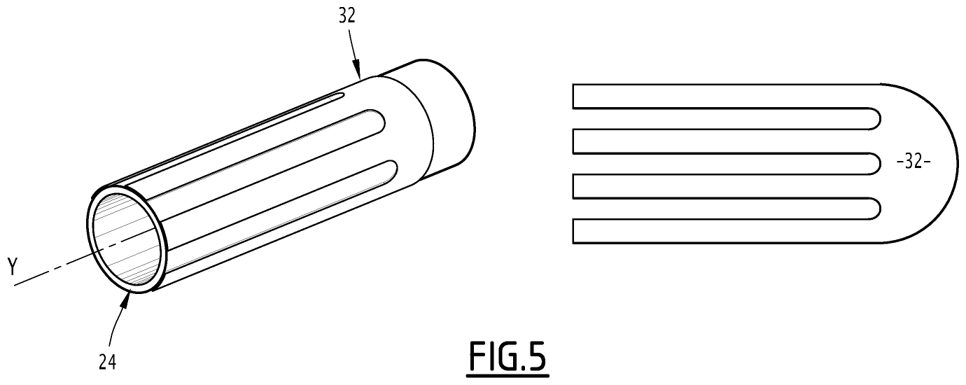

In the examples of FIGS. 2 to 4, the heat diffusion layer 32 is formed by a continuous sheet, for example of a rectangular shape, which is wound inside or outside the support 24. However, other shapes of the heat diffusion layer 32 may also be possible. Thus, as it is shown in the right part of FIG. 5, the heat diffusion layer 32 may be formed from a sheet comprising a plurality of finger parts (four in the example of the figure). These finger parts are intended to extend longitudinally along the device axis Y when the heat diffusion layer 32 is wound around the support 24 as it is shown in the left part of the same figure. In this configuration, the heat diffusion layer 32 covers only partially the external surface of the support 24. In variant, the same heat diffusion layer 32 can be arranged on the internal surface of the support 24.

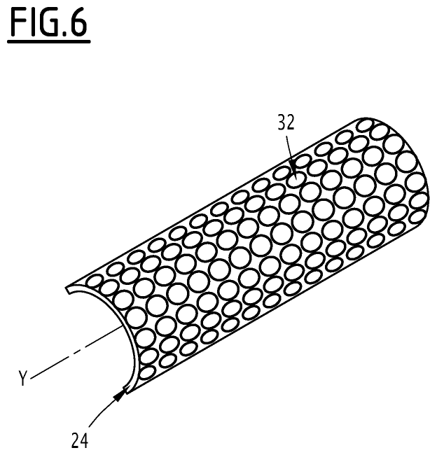

The heat diffusion layer 32 can be arranged in any other suitable manner on the support 24. Thus, as it is shown in FIG. 6, the heat diffusion layer 32 may be realized by inject printing directly on the support 24. This embodiment is particularly advantageous when the heat diffusion layer 32 is made of graphene. In some embodiments, the heat diffusion layer 32 may be formed by several sheets.

Advantageously according to the invention, the heat diffusion layer 32 comprises or is formed from graphene. Additionally, the heat diffusion layer 32 may be made at least partially transparent. For example, it may be transparent over more than 90% of its surface. The transparency of the heat diffusion layer 32 may be comprised between 10% and 100%, advantageously between 20% and 90%.

According to the invention, the sensor system 28 is integrated into the heater 27 and comprises notably at least partially the heat diffusion layer 32. This means that the sensor system 28 comprises one or more sensors formed at least partially by the heat diffusion layer 32 or one or more sensors cooperating with the heat diffusion layer 32 to provide corresponding measurements. The arrangement of the sensors of the sensor system 28 depends on the nature of these sensors and the measurements that they are able to provide.

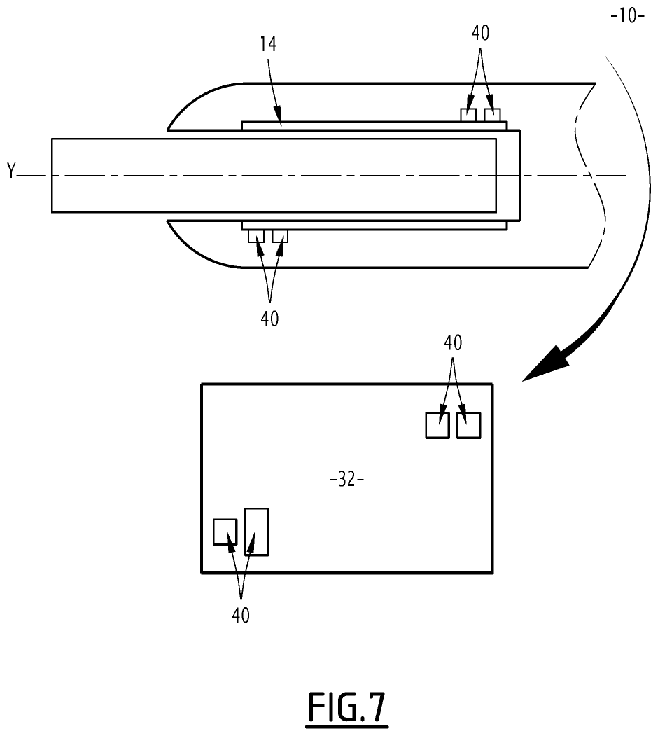

In the example of FIG. 7, four sensors 40 are integrated in the heat diffusion layer 32. Particularly, as shown in this figure, the sensors 40 can be integrated two-by-two in opposite corners of the sheet forming the heat diffusion layer 32. Thus, when the heat diffusion layer 32 is wound around the device axis Y, the sensors are located on different ends of the cavity: two sensors adjacent to its open end and two sensors adjacent to its closed end.

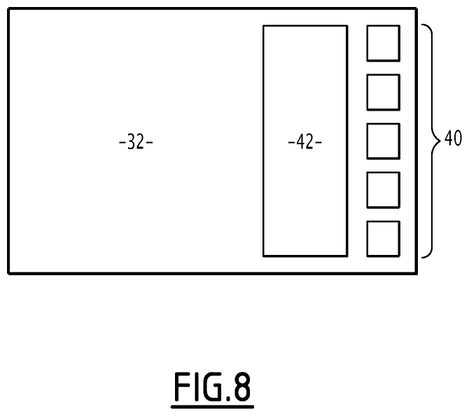

In the example of FIG. 8, an array of five sensors 40 is arranged at one end of the sheet forming the heat diffusion layer 32. Thus, when this sheet is wound around or inside the support 24, the sensors 40 are located circumferentially around the cavity 14. According to this example, a gap 42 can space the array of sensors 40 for example from a heating element integrated in the heat diffusion layer 32.

Of course, sensors of the sensor system 28 can be arranged in respect with the heat diffusion layer 32 according to any other suitable manner.

According to the invention, the or each sensor is able to detect at least one of the following events/elements:
insertion of the tobacco article 12 inside the cavity 14;
movement of the tobacco article 12 in respect with the cavity 14;
tactile command;
contamination level of the cavity 12;
electromagnetic waves, notably optical signals;
temperature;
pressure;
a chemical element;
a gas.

These elements/events can detected by one or several sensors by measuring at least one of the following parameters:
mechanical deformation;
changing of electrical conductivity;
piezoelectric effect;
changing of polarization. any one of the

Here-below, several examples of sensors making it possible to detect at least one of the pre-cited events/elements using one or serval types of measurements, are given.

### Example 1

According to an example, insertion and/or any other movement of the tobacco article inside the cavity 12 is detected by a sensor measuring a mechanical deformation of at least a part of the heat diffusion layer 32.

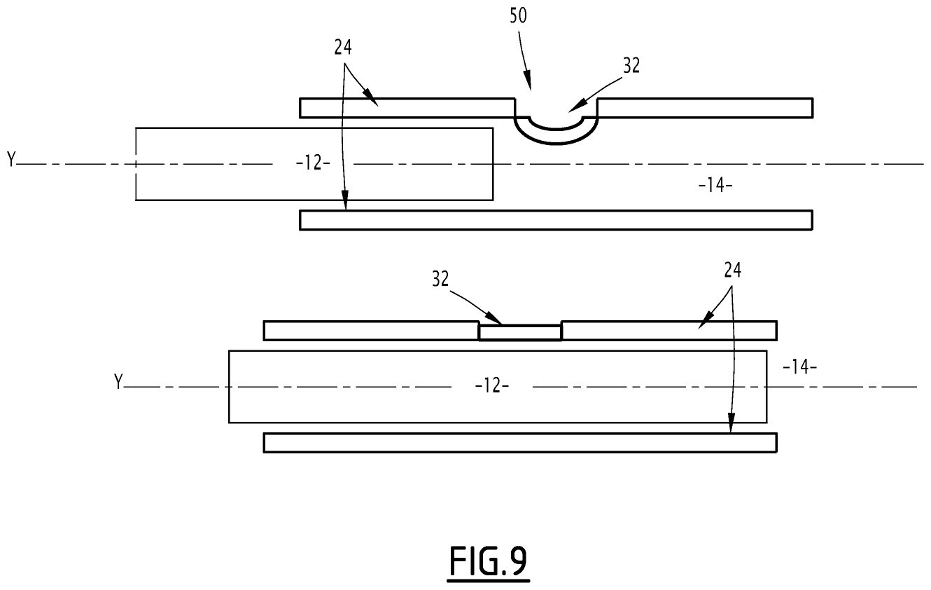

In this case, as it is shown in FIG. 9, the support 24 may comprise a window 50 and the heat diffusion layer 32 maybe arranged inside or outside the support 24 so as to be deformed when the tobacco article 12 is slid along the device axis Y in the neighborhood of the window 50 (bottom part of the figure). The mechanical deformation can be detected by a sensor arranged directly in the heat diffusion layer 32. Optionally, the deformation may be detected electrically or optically by a sensor arranged in the heat diffusion layer 32 or in the neighborhood of this layer 32.

The window 50 can have any suitable shape, like for example:
a cylindrical shape, not necessarily having a uniform diameter over its length;
the shape of a closed or open ring;
a tube or ring having a rectangular or square-shaped cross section or any other non-circular cross-section;
a flat or curved plate having at least one rectangular shaped cross-section;
a window having at least two cross-sections that have different curvatures,
a window having at least one flat side and at least one curved side;
an array of transparent and thermal conductive windows.

### Example 2

According to another example, insertion and/or any other movement of the tobacco article inside the cavity 12 is detected using a piezoelectric effect of the heat diffusion layer 32.

In this case, the heat diffusion layer 32 made for example of graphene may be doped with lithium, hydrogen, potassium and fluorine, as well as combinations of hydrogen and fluorine and lithium and fluorine on either side of the lattice. Doping just one side of the graphene, or doping both sides with different atoms, is key to the process as it breaks graphene's perfect physical symmetry, which otherwise cancels the piezoelectric effect. This makes the heat diffusion layer 32 piezoelectric, if it is not originally piezoelectric.

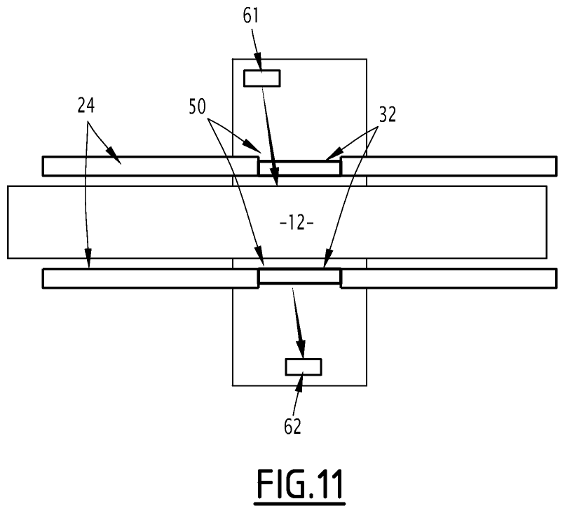

In variant, insertion and/or any other movement of the tobacco article inside the cavity 12 is detected using optical signals. This variant is schematically shown in FIG. 11.

According to FIG. 11, two windows 50 are arranged in the support 24 to face each other. Each window 50 is overlapped with the heat diffusion layer 32. In this case, the sensor system 28 comprises an optical emitter 61 arranged to face one of the windows 50 and an optical receiver 62 arranged to face the other window 50. Both emitter 61 and receiver 62 can be connected to the controller 29. The controller 29 can for example detect the presence of the tobacco article 12 in the cavity 14 when optical signals emitted by the emitter 61 are not received by the receiver 62 or received but in a modified form.

In this example, it is considered that the heat diffusion layer 32 is at least partially transparent to at least some optical signals (visible, infrared or UV).

### Example 3

According to another example, one or more tactile sensors may be arranged for example at the outer surface of the device. For example, these sensors can be integrated in a graphene layer and connected to the controller 29 to transmit corresponding tactile commands. Thus, the sensors can have a broader sensitivity.

In order to avoid a direct contact of the user's fingers with the graphene layer, a mechanical system intended to extend between the user's finger and the surface of the graphene layer may be provided. Such a mechanical system comprises for example one or several buttons intended to be actuated by the user and thermally isolating connecting means. These connecting means connect for example the or each button to the corresponding tactile sensor on the graphene layer and may further comprise a biasing element, as a spring or another elastic element, to cause the button to take its initial position after being actuated by the user.

### Example 4

According to another example, at least one sensor is used as a contamination sensor for monitoring the contamination level of the cavity 14.

The electrical conductivity of some materials, such as for example graphene, changes with the binding of substances, called analytes, to its surface and their chemical constituents may be identified and measured. The magnitude of the conductivity change can be correlated to the concentration of deposited contaminants on the heat diffusion layer 32. Such sensor may be electrical sensor or optical sensor.

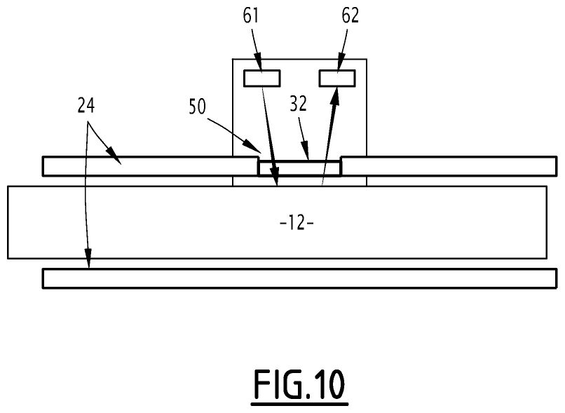

An example of an optical sensor is shown in FIG. 10. According to this example, the sensor system 28 comprises an optical emitter 61 and an optical receiver 62 which are arranged to face a window 50 formed in the support similarly to the window 50 of FIG. 9. In this case, the heat diffusion layer 32 made for example of graphene may overlap the window 50 so as the emitter 61 is able to emit optical signals crossing the heat diffusion layer 32 and the receiver 62 is able to receive optical signals reflected for example by the outer surface of the tobacco article 12. Both emitter 61 and receiver 62 can be connected to the controller 29. By comparing the reflected optical signals with the emitted optical signals, the controller 29 can be adapted to determine a contamination level of the heat diffusion layer 32.

In this example, it is considered that the heat diffusion layer 32 is at least partially transparent to at least some optical signals (visible, infrared or UV).

### Example 5

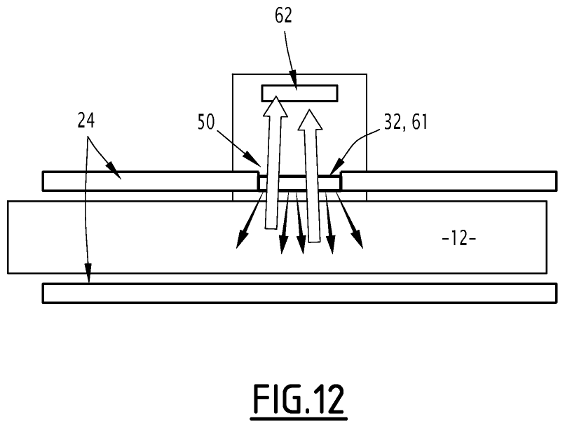

According to another example, the sensor system 28 comprises an optical emitter 61, such for example a light source, which is integrated in the heat diffusion layer 32, as it is shown in FIG. 12. In this case, the arrangement of the heat diffusion layer 32 and the structure 24 can be similar to one shown in FIG. 10. Particularly, as in the case of FIG. 10, the sensor system 28 comprises an optical receiver 62 facing the window 50. The only difference of the arrangement of FIG. 12 is that the optical emitter 61 is integrated in the heat diffusion layer 32 in the window 50.

This arrangement can be used for similar detection purposes as those explained above. Additionally, as in the previous cases, it is considered that the heat diffusion 32 layer is at least partially transparent to at least some optical signals (visible, infrared or UV).

### Example 6

According to another example, the heat diffusion layer 32 made for example of graphene, may be configured so that it behaves as an adaptable polarizer. This might be exploited to detect optical codes that are arranged on the smoking article 12 and which have polarization properties.

For these purposes, one of the arrangements explained in reference to FIGS. 10 to 12 may be used. Particularly, in this case, the sensor system further comprises an optical emitter 61 and an optical receiver 62 similar to those explained in reference to these figures.

### Example 7

According to another example, the heat diffusion layer 32 made of graphene in the form of graphene oxide (CO) may be configured as a fluorescent layer which emitted wavelength may be varied by changing the wavelength of the excitation light. For fluorescence applications, its fluorescent properties can be modulated by changing its sheet size, chemical composition and other factors. As the graphene layer acts as a fluorescent layer, it behaves as an emitting diffuser and may also be used in an optical anti-counterfeit sensor for smoking articles.

### Example 8

According to another example, at least one sensor is used as a contamination sensor for monitoring the contamination level of the cavity 14, as in the Example 4.

However, in this case, the heat diffusion layer 32 made of graphene may be configured as an optical receiver to detect deposited contamination layers by measuring the variation of the refractive index of the graphene layer. The excellent optical and electronic properties of graphene make it attractive for sensors that use electromagnetic waves known as plasmons that propagate along the surface of a conducting material in response to light exposure. A substance can be detected by the controller 29 by measuring how the refractive index of the sensor changes when a substance of interest is close to the graphene's surface.

### Example 9

According to another example, the heat diffusion layer 32 made of graphene may be used as a high-mobility photoconductive layer in a detector that detects UV, visible and infrared light. Existing vision systems based on silicon only can detect visible light and limited up to 1.5 μm. Graphene may be used as a photon-electric charge converter by using a layer comprising quantum dots, that are now widely available.

Thus, a vision system or intensity detector system may be provided to detect wavelengths from the UV up to the mid-infrared.

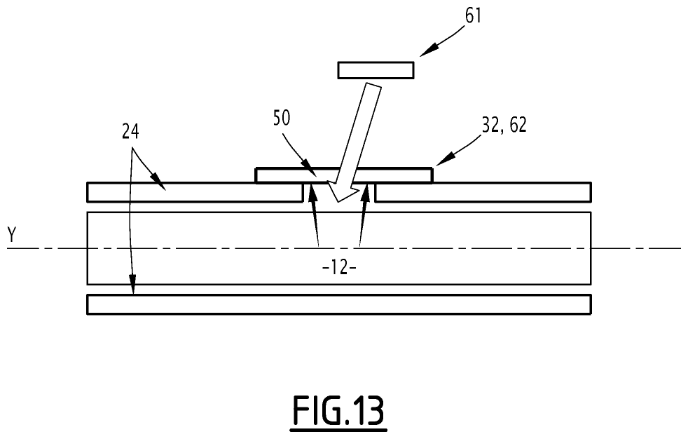

This case is shown schematically in FIG. 13 where the heat diffusion layer 32 is transparent and may be used to transmit light from an optical emitter 61 and at the same time detect light. In other words, in this case, the heat diffusion layer 32 acts as an optical receiver 62.

1. An aerosol generating device comprising:
a cavity adapted for receiving a tobacco article;
a heater comprising a heating element configured to generate heat and a heat diffusion layer formed by a sheet and configured to transfer the generated heat to the tobacco article when the tobacco article is received in the cavity, the heater further comprising a sensor system;
the sensor system comprising:
at least partially the heat diffusion layer;
one or more sensors formed at least partially by the heat diffusion layer or one or more sensors cooperating with the heat diffusion layer.

2. The aerosol generating device according to claim 1, wherein the heat diffusion layer is a graphene layer.

3. The aerosol generating device according to claim 1, wherein the heat diffusion layer is arranged between the heating element and the tobacco article when the tobacco article is received in the cavity.

4. The aerosol generating device according to claim 1, wherein each of the one or more sensors is configured to detect at least one of the following events/elements:
insertion of the tobacco article inside the cavity;
movement of the tobacco article with respect to the cavity;
tactile command;
contamination level of the cavity;
electromagnetic waves;
optical signals;
temperature;
pressure;
a chemical element; or
a gas.

5. The aerosol generating device according to claim 4, wherein one or several of the events/elements are able to be detected by measuring at least one of the following parameters of the corresponding sensor:
mechanical deformation;
changing of electrical conductivity;
piezoelectric effect; or
changing of polarization.

6. The aerosol generating device according to claim 1, wherein the heat diffusion layer forms an at least partially transparent window configured to be arranged between one of the one or more sensors and the tobacco article when the tobacco article is received in the cavity.

7. The aerosol generating device according to claim 1, wherein:
the one or more sensors comprises a plurality of sensors;
arranged in corner sections and/or forming an array of/on the sheet forming the heat diffusion layer.

8. The aerosol generating device according to claim 1, wherein the sensor system further comprises at least one optical emitter configured to emit an optical signal.

9. The aerosol generating device according to claim 8, wherein the at least one optical emitter is formed at least partially in the heat diffusion layer or is able to emit optical signals crossing the heat diffusion layer.

10. The aerosol generating device according to claim 1, wherein the heating element is integrated at least partially in the heat diffusion layer.

11. The aerosol generating device according to claim 1, further comprising a support delimiting at least partially the cavity and defining an inner surface configured to face or be in contact with the tobacco article when the tobacco article is received in the cavity, and an outer surface opposite to the inner surface;
the heat diffusion layer being arranged on the inner surface or on the outer surface of the support.

12. The aerosol generating device according to claim 11, wherein the support is formed by at least one of the following elements:
a hollow cylinder;
longitudinal bars;
transversal rings; or
a grid.

13. The aerosol generating device according to claim 11, wherein the support is made of metal, or from a substantially transparent material.

14. The aerosol generating device according to claim 1, wherein the sheet forming the heat diffusion layer is continuous or comprises a plurality of finger parts designed to extend longitudinally.

15. The aerosol generating device according to claim 1, wherein the heat diffusion layer is substantially transparent.

16. The aerosol generating device according to claim 11, wherein the support is made of aluminum or copper.

17. The aerosol generating device according to claim 11, wherein the support is made of SiO₂ or Al₂O₃.
